(19) United States
(12) Patent Application Publication
(10) Pub. No.: US 2024/0021987 A1
(43) Pub. Date: Jan. 18, 2024

(54) Wireless Communication Device

(71) Applicant: KMW INC., Hwaseong-si (KR)

(72) Inventors: Sung Hwan SO, Hwaseong-si (KR); Sung Man KANG, Hwaseong-si (KR); Cha Gun KANG, Hwaseong-si (KR)

(73) Assignee: KMW INC., Hwaseong-si (KR)

(21) Appl. No.: 18/372,718

(22) Filed: Sep. 26, 2023

Related U.S. Application Data
(63) Continuation of application No. PCT/KR2022/004070, filed on Mar. 23, 2022.

(30) Foreign Application Priority Data
Mar. 30, 2021 (KR) 10-2021-0040839
Mar. 23, 2022 (KR) 10-2022-0035706

(51) Int. Cl. H01Q 5/28; H01Q 1/24; H01Q 1/38

(52) U.S. Cl. CPC H01Q 5/28; H01Q 1/246; H01Q 1/38

(57) ABSTRACT

A wireless communication device is disclosed. According to at least one embodiment of the present disclosure, a wireless communication device is provided, comprising a first antenna housing, a mounting space formed in at least part of the first antenna housing, and a plurality of first antenna elements disposed in the first antenna housing and configured to transmit and receive a first signal.

### CROSS-REFERENCE TO RELATED APPLICATION

This application is a continuation of International Application No. PCT/KR2022/004070, filed on Mar. 23, 2022, which claims priority from Korean Patent Application Nos. 10-2021-0040839 filed on Mar. 30, 2021 and 10-2022-0035706 filed on Mar. 23, 2022, the disclosures of which are incorporated by reference herein in their entirety.

### TECHNICAL FIELD

The present disclosure relates to a wireless communication device.

### BACKGROUND ART

The description in this section merely provides background information on the present disclosure and does not necessarily constitute the related art.

A wireless communication device used for transmitting and receiving radio signals is usually installed in an outdoor environment, such as on the roof of a building.

Research for improving the size and design of wireless communication devices is being conducted in various fields, in order to prevent the wireless communication devices from harming the aesthetic appearance of the building. Yet, improvements in design and size are being made in a limited fashion in terms of maintaining the functionality of the wireless communication device.

In particular, with the increase in frequency band used for communication, it is becoming inevitable to install an additional wireless communication device. By disposing a wireless communication device that covers a new frequency band, the space occupied by wireless communication devices is becoming increasingly larger.

Another drawback is that, if the frequency band covered changes with time after the installation of a wireless communication device, the wireless communication device need to be fully replaced.

### DISCLOSURE

### Technical Problem

In view of this, a primary aspect of the present disclosure is to dispose an additional communication device for another frequency band without an increase in the size of wireless communication devices.

Another primary aspect of the present disclosure is to facilitate installation by using a cartridge-type wireless communication device without fully replacing a wireless communication device, when an additional wireless communication device covering a new frequency band needs to be disposed in an area where an existing wireless communication device is disposed.

Yet another primary aspect of the present disclosure is to attach or remove a wireless communication device that covers a new frequency band, while keeping an existing wireless communication device operating.

A further primary aspect of the present disclosure is to reduce replacement costs simply by replacing a cartridge-type wireless communication device, if a frequency band covered is changed in a place where an existing wireless communication device is disposed.

A further primary aspect of the present disclosure is to reduce manufacturing costs by producing various kinds of small-sized, cartridge-type antennas, rather than by producing various kinds of wireless communication devices in accordance with the frequency band covered.

The aspects of the present disclosure are not limited to the foregoing, and other aspects not mentioned herein will be able to be clearly understood by those skilled in the art from the following description.

### Technical Solution

At least one aspect of the present disclosure provides a wireless communication device comprising: a first antenna housing: a mounting space formed in at least part of the first antenna housing; and a plurality of first antenna elements disposed in the first antenna housing and configured to transmit and receive a first signal.

### Advantageous Effects

In accordance with an embodiment of the present disclosure, a wireless communication device has the effect of mounting a second communication device within a mounting space without an increase in the size of wireless communication devices, by providing the mounting space within a first communication device.

Another advantageous effect is that the second communication device can be easily mounted while keeping the first communication device operating.

### DESCRIPTION OF DRAWINGS

FIG. 1 is a perspective view of a wireless communication device according to an embodiment of the present disclosure.

FIG. 2 is a cross-sectional view taken along the line A-A of FIG. 1.

FIG. 3 is an exploded perspective view of a wireless communication device according to an embodiment of the present disclosure.

FIG. 4 is an exploded perspective view of a wireless communication device according to another embodiment of the present disclosure.

FIG. 5 is a view showing a dummy cover replacing the second communication device in FIG. 3.

FIG. 6 is a view showing a dummy cover replacing the second communication device in FIG. 4.

### MODE FOR DISCLOSURE

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Additionally, various ordinal numbers or alpha codes such as first, second, i), ii), a), b), etc., are prefixed solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary.

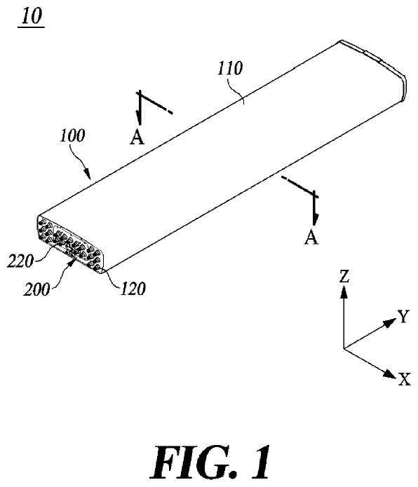

In this specification, “width” refers to a length in a direction parallel to the X axis with respect to FIG. 1, and “thickness” refers to a length in a direction parallel to the Z axis with respect to FIG. 1. Also, “length direction” refers to a direction parallel to the Y axis.

FIG. 1 is a perspective view of a wireless communication device according to an embodiment of the present disclosure.

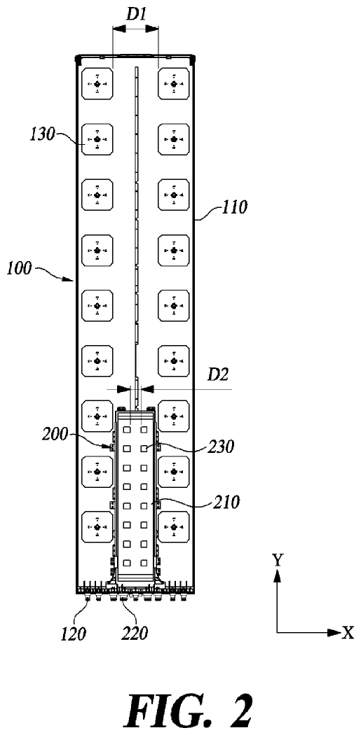

FIG. 2 is a cross-sectional view taken along the line A-A of FIG. 1.

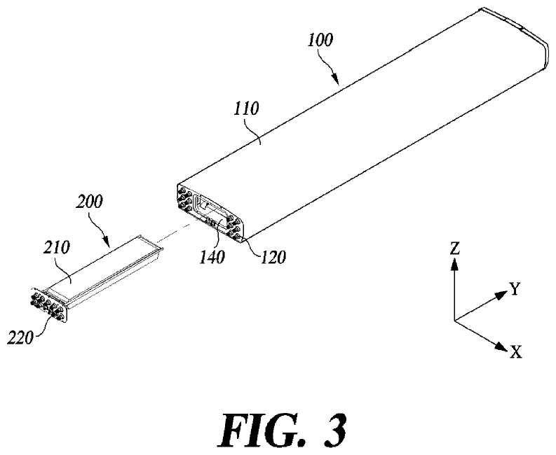

FIG. 3 is an exploded perspective view of a wireless communication device according to an embodiment of the present disclosure.

Referring to FIGS. 1 to 3, a wireless communication device 10 may include a first communication device 100 and a second communication device 200. The first communication device 100 includes a first antenna housing 110, a first input/output port 120, a plurality of first antenna elements 130, and a mounting space 140. The second communication device 200 may include a second antenna housing 210, a second input/output port 220, and a plurality of second antenna elements 230.

One side of the first antenna housing 110 may be configured as a radome. Since the first antenna housing 110 has a receiving space inside, the plurality of first antenna elements 130 and other internal substrates may be held in the receiving space. Through this, the first antenna housing 110 may protect the first antenna elements 130 and other internal substrates from external impact.

The first antenna housing 110 may be shaped in such a way that the vertical length is larger than the horizontal length.

The first communication device 100 according to an embodiment of the present disclosure may provide a receiving space having a relatively large cross-sectional area, by making one of the vertical and horizontal lengths of the first antenna housing 100 longer than the other.

A plurality of first input/output ports 120 may be formed on one side of the first antenna housing 110. The first communication device 100 may be connected to an external device or another wireless communication device 10 using the first input/output ports 120.

The plurality of first input/output ports 120 may include an alarm port, an optical port, a power port, and an RTS port, but the present disclosure is not limited thereto.

Although FIG. 1 depicts a total of twelve first input/output ports 120, the present disclosure is not limited to this.

The plurality of first antenna elements 130 are disposed in the first antenna housing 110 and configured to transmit and receive a first signal. Here, the first signal has a particular frequency band, preferably, a frequency band of 698 MHZ to 894 MHz or a frequency band of 1,696 MHz to 2,400 MHz. However, the present disclosure is not limited to this, but may have different frequency bands depending on the purpose and use.

Referring to FIG. 2, sets of two first antenna elements 130 disposed in the width direction are arranged at preset intervals along the length direction. The larger the frequency band of a first signal, the smaller the distance D1 between two first antenna elements 130 disposed in the width direction becomes. For example, the distance D1 may be from 0.5 lamda to 1.0 lamda. That is, the lower the frequency of the first signal, the longer the wavelength gets, and the wider the distance gets.

The mounting space 140 is formed in at least part of the first antenna housing 110. The mounting space 140 may be formed by cutting open at least part of one side of the first antenna housing 110 along the length direction. Preferably, the mounting space 140 is formed by cutting open at least part of one side where the first input/output ports 120 is disposed.

The mounting space 140 may be formed in at least part of a space between two first antenna elements 130 that are disposed in the width direction. The width of the mounting space 140 is smaller than the distance D1 between two first antenna elements 130 that are disposed in the width direction. Also, the mounting space 140 is formed between two first antenna elements 130 that are disposed in the width direction.

The present disclosure has a technical feature of providing various frequency bands without an overall increase in the volume of the wireless communication device 10, by mounting a communication device for transmitting and receiving signals of different frequency bands by using the space corresponding to the distance D1 formed by the frequency of the first signal. This can increase space utilization in a limited space where a wireless communication device is installed. However, as illustrated in FIG. 1, it is not necessary that a plurality of first antenna elements 130 are arranged in two rows along the length direction, with the two rows spaced apart by the distance D1 along the width direction.

The second antenna housing 210 is configured to be inserted into the mounting space 140. The second antenna housing 210 is configured to be inserted and disposed in the mounting space 140.

Since the second antenna housing 210 has a receiving space inside, the plurality of second antenna elements 230 and other internal substrates may be held in the receiving space. Through this, the second antenna housing 210 may protect the second antenna elements 230 and other internal substrates from external impact.

The second antenna housing 210 may be shaped in such a way that the vertical length is larger than the horizontal length.

Since the second communication device 200 is disposed in the mounting space 140 of the first communication device 100, the addition of the second communication device 200 does not change the overall size of the wireless communication device 10. That is, the present disclosure has a technical feature of transmitting and receiving signals of various frequency bands while maintaining the size of the wireless communication device 10.

The plurality of second input/output ports 220 may be formed on one side of the second antenna housing 210.

The second communication device 200 may be connected to an external device or another wireless communication device 10.

The plurality of second input/output ports 220 may include an alarm port, an optical port, a power port, and an RTS port, but the present disclosure is not limited thereto.

When the second communication device 200 is mounted in the mounting space 140 of the first communication device 100, the plurality of second input/output ports 220 may be positioned on the same side as the plurality of first input/output ports 120.

The number of second input/output ports 220 may vary as required. Preferably, four or eight second input/output ports 220 may be provided. The number of second input/output ports 220 of the second communication device 200 may be determined depending on the environment in which the wireless communication device 10 is installed.

The plurality of second antenna elements 230 are disposed in the second antenna housing 210, and are configured to transmit and receive a second signal having a different frequency band from that of the first signal. Here, the frequency band of the first signal may be lower than the frequency band of the second signal. That is, the second antenna elements 230 may transmit and receive a signal in a higher frequency band than the first antenna elements 130. For example, the second signal may have a frequency band of 3,500 MHz to 4,000 MHz. Accordingly, the distance D2 between two second antenna elements 230 disposed in the width direction may be narrower than D1. However, the present disclosure is not limited to this, the second signal may have other frequency bands. Also, as illustrated in FIG. 1, it is not necessary that a plurality of second antenna elements 230 are arranged in two rows along the length direction, with the two rows spaced apart by the distance D2 along the width direction. For example, the plurality of second antenna elements 230 may be arranged in one row at intervals along the length direction.

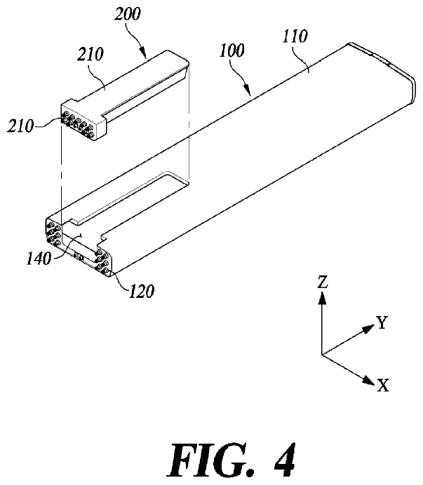

FIG. 4 is an exploded perspective view of a wireless communication device according to another embodiment of the present disclosure.

As illustrated in FIG. 4, the mounting space 140 may be formed in such a way that the second communication device 200 is inserted from above the first communication device 100.

In a case where the first communication device 100 is installed and a plurality of cables are connected to the plurality of first input/output ports 120, the second communication device 200 can be mounted more easily by being inserted from above in the thickness direction of the first communication device 100, as illustrated in FIG. 4.

That is, the second communication device 200 may be mounted without tampering with the plurality of cables connected to the plurality of first input/output ports 120, and without causing the first communication device 100 to stop operating. The second communication device 200 may be slidably mounted and fixed to the mounting space 140.

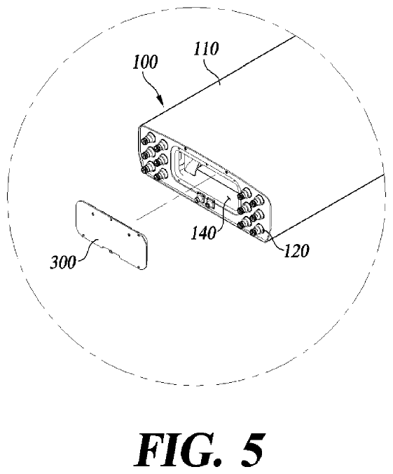

FIG. 5 is a view showing a dummy cover replacing the second communication device in FIG. 3.

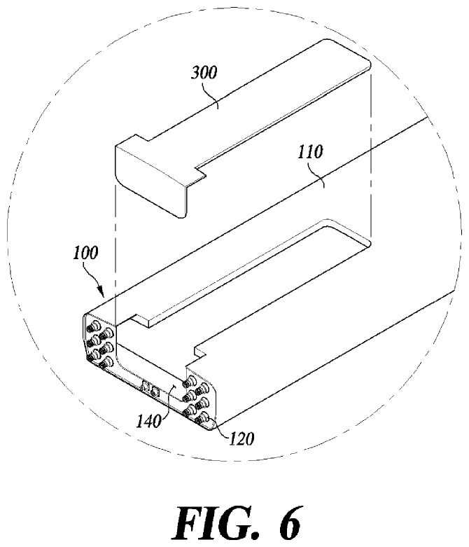

FIG. 6 is a view showing a dummy cover replacing the second communication device in FIG. 4.

If only the frequency band of the first signal is required depending on the environment in which the wireless communication device 10 is installed, the addition of the second communication device 200 may be unnecessary. In this case, the interior of the mounting space 140 can be protected from contamination by external factors by using the dummy cover 300.

The dummy cover 300 may be configured to cover the mounting space 140 to correspond to the shape of the first antenna housing 110. FIG. 5 illustrates the shape of the dummy cover 300 when the mounting space 140 is formed such that the second communication device 200 is mounted in the length direction of the first communication device 100. FIG. 6 illustrates the shape of the dummy cover 300 when the mounting space 140 is formed such that the second communication device 200 is mounted from above the first communication device 100. As illustrated in FIGS. 5 and 6, the dummy cover 300 may be configured to correspond to the shape of the first antenna housing.

In the event that the addition of the second communication device 200 is required during use of the wireless communication device 10 covered with the dummy cover 300, the dummy cover 300 may be removed, and the second communication device 200 may be mounted. In this instance, the first communication device 100 does not need to be stopped from operating.

Accordingly, the present disclosure has a technical feature of eliminating user inconvenience since the present disclosure does not require the existing wireless communication device 10 to stop operating even when the second communication device 200 is added.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

### REFERENCE NUMERALS

10: wireless communication device, 100: first communication device,
110: first antenna housing, 120: first input/output port,
130: first antenna element, 140: mounting space
200: second communication device, 210: second antenna housing
220: first input/output port, 230: second antenna element
300: dummy cover

1. A wireless communication device comprising:
a first antenna housing:
a mounting space formed in at least part of the first antenna housing; and
a plurality of first antenna elements disposed in the first antenna housing and configured to transmit and receive a first signal.

2. The wireless communication device of claim 1, comprising:
a second antenna housing configured to be inserted into the mounting space; and
a plurality of second antenna elements disposed in the second antenna housing and configured to transmit and receive a second signal having a different frequency band from that of the first signal.

3. The wireless communication device of claim 2, wherein the frequency band of the first signal is smaller than the frequency band.

4. The wireless communication device of claim 2, wherein the mounting space is configured such that the second antenna housing is inserted in the length direction of the first antenna housing and held therein.

5. The wireless communication device of claim 2, wherein the mounting space is configured such that the second antenna housing is inserted from above the first antenna housing and held therein.

6. The wireless communication device of claim 2, wherein the plurality of first antenna elements and the plurality of second antenna elements are arranged in two rows at preset intervals along the length direction,
wherein the distance between two first antenna elements disposed in the width direction, among the plurality of first antenna elements, is larger than the distance between two second antenna elements disposed in the width direction among the plurality of second antenna elements.

7. The wireless communication device of claim 1, wherein the plurality of first antenna elements are arranged in two rows at preset intervals along the length direction,
wherein the width of the mounting space is smaller than the distance between two first antenna elements disposed in the width direction, among the plurality of first antenna elements.

8. The wireless communication device of claim 1, further comprising a dummy cover configured to cover the mounting space to correspond to the shape of the first antenna housing.
